(19) United States
(12) Patent Application Publication
(10) Pub. No.: US 2012/0307304 A1
(43) Pub. Date: Dec. 6, 2012

(54) SYSTEMS AND METHODS FOR ON-SITE PRINTING OF CUSTOM ARTICLES

(75) Inventor: Ruben Moreno, Brookline, MA (US)

(73) Assignee: 360BRANDVISION, LLC, Las Vegas, NV (US)

(21) Appl. No.: 13/486,538

(22) Filed: Jun. 1, 2012

Related U.S. Application Data
(60) Provisional application No. 61/493,115, filed on Jun. 3, 2011.

(51) Int. Cl. G06K 15/02

(52) U.S. Cl. 358/1.15

(57) ABSTRACT

This invention relates to the on-site creation of custom articles. Systems and methods of the invention are provided for receiving personalized artwork such as digitally-input freehand drawings and printing the artwork on-site and substantially immediately onto articles of apparel, merchandise, and the like.

### CROSS-REFERENCE TO RELATED APPLICATION

This application claims priority to and the benefit of U.S. Provisional Patent Application No. 61/493,115, filed Jun. 3, 2011, the contents of which are hereby incorporated by reference in their entirety.

### TECHNICAL FIELD

This invention relates to the on-site creation of custom articles, and particularly to systems and methods for receiving freehand drawings and printing them on articles on-location and substantially immediately.

### BACKGROUND

Apparel manufacturing has changed very little over the years. Typically, a piece of apparel is produced in one location and sold in another. These two locations are removed from each other and rarely interact beyond shipping products therebetween. For instance, clothing is typically designed and built to completion prior to being shipped to a retail facility. As such, potential customers are offered a limited selection of clothing designs at the retail facility, even though customers have a wide range of personal tastes.

Likewise, souvenirs and memorabilia sold at concerts and such events are typically designed for a particular event and manufactured before to the event, thus giving customers only a limited set of pre-made products to choose from.

Some entities purport to let customers design their own products on-line. However, customization is typically actually limited to a list of pre-selected options.

### SUMMARY

Systems and methods of the invention are provided for receiving personalized artwork for printing the artwork on-site and substantially immediately or simultaneously (e.g., same day, within an hour or two, or within ten to fifteen minutes) onto articles such as apparel, merchandise, and the like (e.g., articles of clothing, footwear, accessories as well as other types of objects such as umbrellas, luggage, athletic gear and equipment, drink ware, paper stationery, temporary tattoo paper, and the like).

In certain aspects, the invention provides system for creating a customized article that includes an input device to receive data corresponding to a freehand drawing. The system stores the data in a memory and renders the data to create an image file for printing (e.g., in a raster or vector image format). The image file is printed, and the printed image is transferred to an article such as a garment, poster, mug, or mouse pad.

The image file can be printed on transfer paper and transferred by applying heat and pressure to the transfer paper on the article.

The system can include a general purpose computer including a processor coupled to a tangible, non-transitory memory.

In some aspects the invention provides systems and methods for creating a customized temporary tattoo in real-time. Methods of the invention include receiving a digital drawing and rendering it in a medium that can be employed to cause the drawing to appear on the skin of a person. The rendering medium can be tattoo transfer paper, or the drawing can be projected onto skin or printed on a decal.

In some embodiments, the drawing is received through a digital input device that includes a rear projection screen and an infrared drawing tool. In alternative embodiments, the input device is a touchscreen or any other suitable freehand drawing device.

In certain aspects, the invention provides a method for creating a customized article by receiving digital input at a location (e.g., in a retail store or at a business or public event) and storing the input in a computer memory. The input is rendered as an image file and printed onto an article according to methods of the invention.

Methods of the invention include using a device that digital captures a freehand drawing to create the digital input. Suitable devices include electronic drawing tablets, touchscreens, computers such as laptops, desktops and tablet computers, projection screens, infrared drawing tools, cameras and other imaging devices. In certain embodiments, the digital input device comprises a rear-projection screen sensitive to infrared input.

Methods of the invention are conducive to on-site, real-time creation of customized articles. A customer can enter a business or public event, “paint” a picture, and be provided with a t-shirt or similar article having the picture printed on it. Because the “painting” process (the freehand drawing process) is digital, the customer can edit and customize the freehand drawing on-the-fly before committing to the final product. Methods includes using image manipulation software. Software can allow the customer to perform features such as undo, cut, copy, paste, edit color levels, brightness, contrast, invert, select portions, apply a filter, insert text, composite material from multiple files, sources, or input sessions, and perform other digital manipulation.

Methods further include providing the printed article substantially immediately. For example, a t-shirt can be provided within a few minutes, or within an hour or a few hours in various embodiments of the invention. Due to the digital stages of the methods, the images can be shared by or on behalf of the customer. Copies can be emailed to the customer. The customer can share an image on a social networking site, or pull an image from a website such as a social networking site into the computer for use within systems and methods of the invention.

### DETAILED DESCRIPTION

The present invention provides a method for on-site design and printing of fully personalized digital artwork on apparel (e.g., articles of clothing, footwear, accessories, etc.) or on objects such as drink ware, (e.g., cups, mugs, beverage koozies), umbrellas, luggage (e.g., backpacks, gym bags, purses, messenger bags, briefcases, suitcases, etc.), athletic gear and equipment, paper stationery, and the like. More specifically, the present invention employs a computer graphics software program in conjunction with a large screen to allow customers to create freehanded, personal works of digital art on a screen, in the same manner as using a spray can to create graffiti on a wall. The freehanded, personal works of digital art created by the customer are then physically applied to various substrates using a printer to create customized apparel on-site within a retail facility or at a particular event (e.g., concert, movie, theatrical performance, sporting event, meeting, conference, etc.).

### Creating Personalized Digital Art

The computer graphics software program utilized by the invention is an interactive and inventive drawing tool for creating freehanded digital artwork on a large screen (rather than a computer monitor) using a modified spray paint can. Instead of paint, the can ‘sprays’ infra-red light when the cap is pressed, which is tracked by a computer as it moves across the screen. The digital paint appears on the screen wherever the can is sprayed, just like spraying paint on a real wall.

The screen is preferably a large rear-projection screen and can be any shape (e.g., rectangular, square, circular, oval, triangular, etc.) and any size. Preferably, the height of the screen does not substantially exceed the height of the average male or female, so that a customer of average height may utilize the entire screen for creating digital artwork. For example without limitation, the screen can be a rectangular screen that is 2′high (h)×3′ wide (w), 2′h×4′w, 3′h×4′w, 3′h×5′w, 4′h×5′w, 4′h×6′w, 4′h×7′w, 5′h×6′w, 5′h×7′w, 5′h×8′w wide, 6′h×7′w, 6′h×8′w, 6′h×9′w, 7′h×8′w, 7′h×9′w, 7′h×10′w, or any specific value within these ranges.

The screen appears blank, similar to an empty canvas, until the customer begins “drawing” on the screen using the modified spray paint can. The screen is configured to display a tool-bar that allows a customer to select from a menu of ‘paint’ colors, and various spray can nozzle sizes and/or nozzle tips (e.g., decorative tips) for creating freehand art on the screen. The tool bar can be configured to additionally provide a menu of stencil designs, a menu of pre-selected graphics (e.g., clip-art), and/or a text menu for creating personalized messages within the artwork on screen. The digital paint color and/or nozzle can be changed by the customer at any given time using the infra-red beam from the modified spray paint can in a point-and-select manner to browse the menu options and select a different color, a different nozzle size and/or a different nozzle tip. Likewise, the stencil designs, pre-selected graphic options and/or text can be selected and changed by the customer at any given time during the drawing using the infra-red beam from the “spray can”. Once selected, the stencil designs, graphics and/or text can be moved to any location on the screen, rotated or flipped, enlarged, minimized, etc. using the infra-red beam from the modified spray paint can to manipulate the images and/or text. The tool-bar is configured to be displayed upon demand, and minimized when not in-use so as to not interfere with the drawing space on the screen.

In certain embodiments, the freehand digital artwork created by the customer on the screen is in a vector image format. Vector images are defined mathematically as lines, points and curves that can have solid, gradient, or patterned color fills. Vector images can be scaled up or down, to any size, without loss of quality. In other embodiments, the freehanded digital artwork created by the customer on the screen is in a raster image format. Raster image formats use a grid pattern, known as pixels, to represent graphics. Each pixel in a raster image has a specific location and color value assigned to it. Raster graphics typically cannot be scaled to a higher resolution without loss of apparent quality. Digital input of freehand drawing is discussed in U.S. Pat. No. 6,947,033; U.S. Pat. No. 5,604,517; U.S. Pub. 2011/0010676; U.S. Pub. 2008/0036771; and U.S. Pub. 2007/0229457, the contents of which are hereby incorporated by reference in their entirety for all purposes.

### On-Site Printing of Personalized Digital Art on Articles

Once the customer is finished creating their freehanded digital art, the artwork can be physically applied to apparel (e.g., articles of clothing, footwear and accessories) or other types of merchandise (e.g., beverage koozies, umbrellas, luggage (e.g., backpacks, gym bags, purses, messenger bags, briefcases, suitcases, etc.), athletic gear and equipment) using a printer in order to directly or indirectly transfer the digital artwork onto apparel or the like. The computer software program converts the freehand digital artwork into a suitable format for printing (e.g., JPEG, TIFF). The converted image is then sent to a printer. The screen can be directly coupled to a printer or indirectly coupled to a printer via a computer through one or more cable connections (e.g., USB cables, USB flash drive, etc.). Alternatively, the screen can be configured for wireless transmission of the digital artwork to a printer and/or computer.

The freehanded digital artwork image is adjusted to the desired size for application to the desired garment or other object. The print job is then “mirrored” or “flipped” so that the image is in the proper orientation when transferred onto the garment, apparel or other merchandise.

In certain embodiments, the screen is coupled to a digital printer to directly print the freehand digital artwork image onto a desired garment, apparel, or other merchandise (e.g., articles of clothing or accessories (e.g., hats, scarves, hats, bags, etc.)) using textile ink. In other words, the digital artwork is transferred to the desired garment, apparel, or other merchandise using directly-applied textile ink. Examples of digital printers suitable for printing on textiles/garments include, but are not limited to, the Freejet 330TX, the Kornit Avalanche 951, Kornit Storm 9318, Kornit Thunder 9326, Kornit Paradigm 933, and Kornit Breeze 921.

In some embodiments, the garment/apparel/textile on which the digital artwork is to be printed is treated with a pre-treatment solution (e.g., a wetting solution that contains wetting additives) prior to printing. The pre-treatment solution is applied directly to the printing area to prepare the surface to accept the textile ink. A chemical reaction between the pre-treatment solution and the textile ink allows the ink to bind to the garment's fibers, to create an optimum, wash resistant printing result. In certain embodiments, the pre-treatment step is performed using a pre-treatment machine, such as, for example, the Viper XPT-6000. In some embodiments, the pre-treatment solution, once applied to the printing area on the garment/textile, is heated and allowed to cool and dry prior to printing. Once the printing is complete, the printed garment/textile is placed on a heated dry rack to fix the ink to the fabric (i.e., heat fixation). The dry rack may employ infrared heat, a fan, convection heating, or a combination thereof.

In other certain embodiments, the freehanded, personal artwork is applied onto a desired garment, apparel, or other merchandise (e.g., articles of clothing or accessories (e.g., hats, scarves, hats, bags, etc.) using an inkjet or a color laser printer and transfer paper, thus allowing the artwork to be physically applied to the apparel or other merchandise on-site. The transfer paper can be designed for use on white and light colored fabrics or designed for use on dark colored fabrics.

The inkjet transfer paper is fed into the printer like regular paper, and the image is printed and then applied to garments with a standard home iron or a heat press. Examples of suitable heat presses include, without limitation, HIX heat presses such as the HT-600D, HT-400D, Presto15, Presto20, N-880D, N-680D, S-650P, S-450P, SwingMan 20D, SwingMan 25D, SwingMan 15, and the Hobby Lite. The garment/apparel is first ironed or heat pressed for a few seconds to remove any residual moisture. The printed transfer is then placed onto the garment/apparel and ironed or heat-pressed for 8-10 seconds. The transfer is peeled away immediately before it is allowed to cool. The process is similar with laser transfer paper.

In alternative embodiments, the digital artwork is transferred onto a desired garment, apparel, or other merchandise (e.g., articles of clothing or accessories (e.g., hats, scarves, hats, bags, etc.) using screen printing. Screen printing uses screens as stencils in order to directly imprint ink onto the fabric of the shirt. The original freehand digital art created by the customer is printed onto a screen and a different screen is needed for each color that is used in the design. Once imprinted, the fabric of the t-shirt absorbs the ink, fusing the design and the shirt into one entity. Printing articles is discussed further in U.S. Pat. No. 7,607,745; U.S. Pat. No. 5,161,466; U.S. Pub. 2011/0109686; and U.S. Pub. 2003/0101559, the contents of which are hereby incorporated by reference in their entirety for all purposes.

In still other embodiments, the freehanded, personal digital artwork is printed onto temporary tattoo decal paper using a digital printer, an inkjet printer, or a color laser printer. Thus, the present invention enables customers to design their own temporary tattoos using the methods described herein. The freehanded digital artwork image is adjusted to the desired size for application to a desired location on the customer's body. The print job is then “mirrored” or “flipped” so that the image is in the proper orientation when transferred onto the desired bodily location.

The present invention enhances a customer's shopping experience in real-time by allowing them to design and print their own apparel/garment on-demand. The customer can both design their own apparel/souvenir and walk away with the item within a matter of minutes, thereby providing immediate gratification.

In the situation of an event such as a movie, theatrical performance, a concert or a sporting event, conference or meeting, the customer can design their own freehanded artwork to be applied to an event souvenir or memorabilia, and indicate their seating location. The personal artwork is then applied to the desired souvenir or memorabilia and delivered to the customer at their seat during the event, to avoid having to wait in long lines and missing part of the event.

In some embodiments, the freehand digital artwork created by the customer can be uploaded and saved to a computer via a cable coupling or via wireless transmission from the screen to the computer. The computer stored image can be converted into one or more formats (e.g., JPEG, TIFF) suitable for emailing, texting or posting the picture to a website (e.g., a social media website such as Facebook, MySpace, etc.). Systems for custom articles are discussed in U.S. Pat. No. 6,564,118 and U.S. Pub. 2009/0034012, the contents of which are hereby incorporated by reference in their entirety for all purposes.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. A system for creating a customized article, the system comprising:
an input device to receive data corresponding to a freehand drawing;
a tangible, non-transitory memory coupled to the input device and configured to store a digital file comprising the data;
a processor coupled to the memory and configured to execute a software program to render the data to create an image file for printing and send the image file to the printer;
a printer coupled to the processor and configured to print the image file; and
an apparatus for transferring the printed file to an article.

2. The system of claim 1, wherein the input device comprises an infrared device and a projection screen.

3. The system of claim 1, wherein the image file is printed on transfer paper, and the apparatus operates by applying heat and pressure to the transfer paper on the article.

3. The system of claim 1, wherein the memory and processor are provided by a computer, and the input device, the computer, the printer, and the apparatus are housed at one location.

4. The system of claim 1, wherein the article is selected from the group consisting of a t-shirt, a sweat-shirt, a jacket, sweatpants, a hat, and a scarf.

5. The system of claim 1, wherein the digital drawing is a vector image format.

6. A system for creating a customized temporary tattoo in real-time, the method comprising the steps of:
receiving, via a digital input device, a digital drawing;
storing the digital drawing in a tangible, non-transitory memory coupled to the digital input device; and
rendering, using a processor coupled to the memory, the digital drawing in a medium that can be employed to cause the drawing to appear on the skin of a person.

7. The system of claim 6, wherein the digital input device comprises a rear-projection screen.

8. The system of claim 6, wherein the received digital drawing is created through the use of a computer graphics software program executed by the processor.

9. The system of claim 6, wherein the receiving step comprises translating an infra-red signal into a digital signal defining the digital drawing.

10. The system of claim 9, wherein the rendering step comprises printing the digital drawing onto tattoo transfer paper.

11. The system of claim 6, wherein the rendering step comprises printing a decal.

12. The system of claim 6, wherein the rendering step comprises projecting the digital drawing onto skin using a projector.

13. A method for creating a customized article, the method comprising:
receiving, via a digital input device, digital input at a location;
storing the digital input in a tangible, non-transitory memory coupled to the digital input device;
rendering, using a processor coupled to the memory, the digital input as an image file; and
printing the image file onto an article.

14. The method of claim 13, wherein the digital input is created by using the digital input device for freehand drawing.

15. The method of claim 14, wherein the digital input device comprises an infrared device.

16. The method of claim 14, wherein the digital input device comprises a rear-projection screen sensitive to infrared input.

17. The method of claim 13, wherein the location is a site of a business and the printing occurs at the location.

18. The method of claim 17, wherein the printing occurs within one hour of the receiving.

19. The method of claim 13, wherein the article is a garment.

20. The method of claim 13, further comprising sending the image file to a recipient.
